(19) United States
(12) Patent Application Publication
(10) Pub. No.: US 2009/0019715 A1
(43) Pub. Date: Jan. 22, 2009

(54) INTEGRATED GAUGING AND ROBOTIC APPARATUS AND METHOD

(75) Inventor: J. Donald Engles, Shoreview, MN (US)

Correspondence Address: SCHWEGMAN, LUNDBERG & WOESSNER, P.A., P.O. BOX 2938, MINNEAPOLIS, MN, 55402, US

(73) Assignee: Productivity Inc.

(21) Appl. No.: 11/780,295

(22) Filed: Jul. 19, 2007

(51) Int. Cl. G01B 5/004; B65G 1/137

(52) U.S. Cl. 33/503; 414/751.1

(57) ABSTRACT

An apparatus includes a robotic arm in one example. A workpiece holding portion is coupled to the robotic arm and is configured to selectively hold a workpiece. At least one measurement device is coupled with the workpiece holding portion and is configured to measure a property of the workpiece while being held by the workpiece holding portion. In another example, a method includes automatically measuring at least one property of the workpiece while the workpiece is moved from one location to another.

### TECHNICAL FIELD

This invention relates generally to automated equipment. Specifically, this invention relates to an integrated gauging and robotic apparatus and method.

### BACKGROUND

Operations, such as machining operations, are known to employ automated arms for placement of workpieces within and/or removal of workpieces from at least partially automated machining devices, such as, for instance computer numerical control (CNC) machines. For instance, a robotic arm can be used to remove a workpiece from a CNC machine and place the workpiece in a pallet, on a conveyor belt for transport to another station, or in another device for further machining or processing.

It is often desirable to inspect such workpieces during manufacturing in order to determine whether pieces are within a predetermined tolerance, determine whether pieces are of a particular surface quality, or otherwise maintain generally similar properties between workpieces. For instance, such inspections can be used to generate parameters for process control. Such inspections often include manually measuring one or more properties of the workpiece between stations. For instance, a machinist or other technician will often remove a workpiece from the manufacturing line to measure, for instance, a dimension of the workpiece. If the measurement falls within an acceptable range, the workpiece will either be further measured or inspected, or, if satisfactory, will be placed back in the manufacturing line to be completed, packaged, etc. Removing the piece from the line in this way increases manufacturing time per piece, which translates to increased costs associated with the manufacture of each workpiece.

It would, therefore, be desirable to automatically measure at least one property of a workpiece in a way that does not increase manufacturing time for the workpiece.

### BRIEF DESCRIPTION OF THE DRAWINGS

FIG. 1 is a perspective view of an example of a workpiece holding portion;

FIG. 2 is a perspective view of the workpiece holding portion of FIG. 1 holding an example of a workpiece;

FIG. 3A is a side elevational view of the workpiece holding portion of FIG. 2;

FIG. 3B is a plan view of the workpiece holding portion of FIG. 2;

FIG. 3C is a cross-sectional view of the workpiece holding portion of FIG. 3A taken along line 3C-3C;

FIG. 4 is a perspective view of an example of a measurement device for use with a workpiece holding portion, such as the example shown in FIG. 1;

FIG. 5 is a perspective view of an example of an actuator for use with a workpiece holding portion, such as the example shown in FIG. 1; and

FIG. 6 is a block diagram of an example of a system that includes an example of an integrated gauging and robotic apparatus.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated.

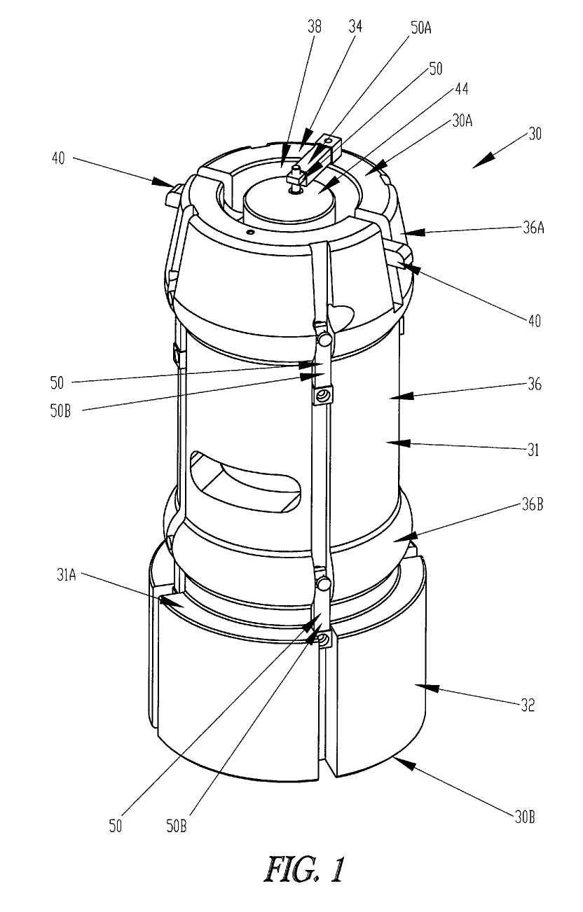

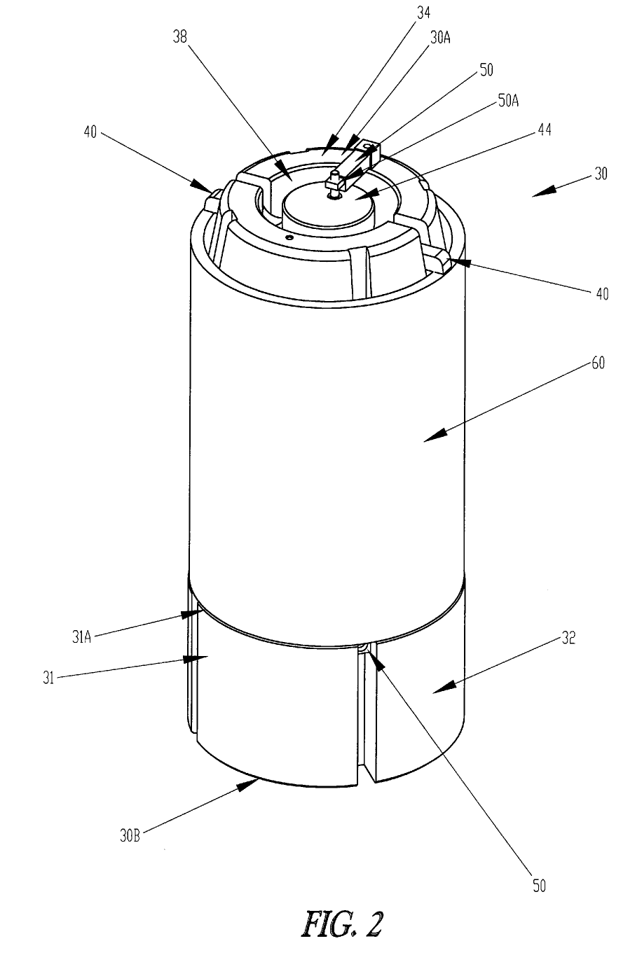

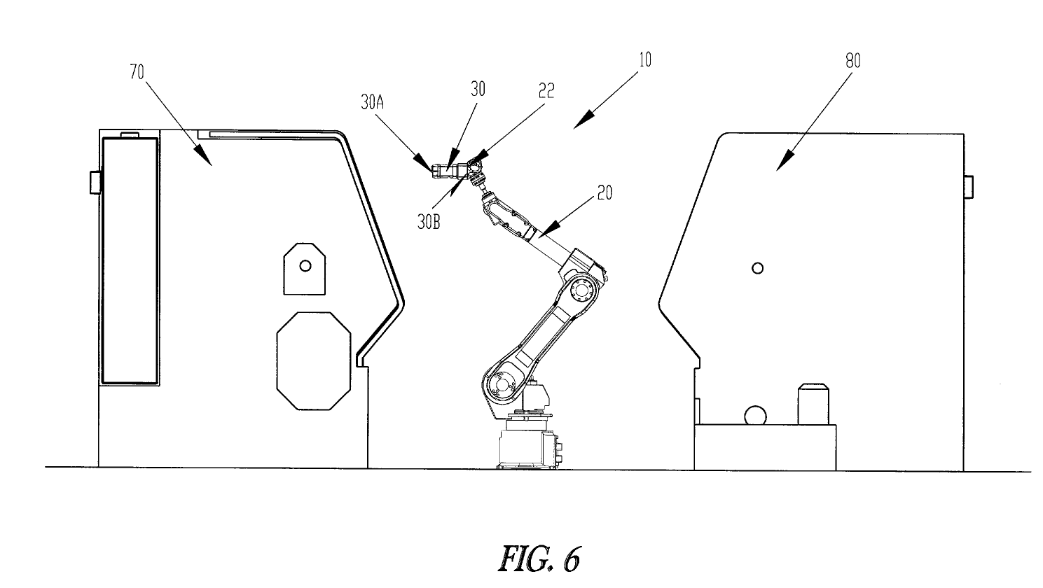

Referring to FIGS. 1, 2, and 6, an example of an apparatus 10 (FIG. 6) is shown for use in operations, such as, but not limited to, manufacturing operations. An example of such a manufacturing operation is a machining operation in which a computer numerical control (CNC) machine is used to produce, at least in part, a workpiece 60. The apparatus 10, in this example, includes a robotic transport arm 20 having a workpiece holding portion 30 coupled thereto. The workpiece holding portion 30 includes a distal end 30A and proximal end 30B. In one example, the workpiece holding portion 30 is coupled to an end 22 of the robotic arm 20. In a further example, the proximal end 30B of the workpiece holding portion 30 attaches to the end 22 of the robotic arm 20. In another example, the workpiece holding portion 30 is removable from the robotic arm 20. In one example, the workpiece holding portion 30 gauges the workpiece 60 while the workpiece 60 is retained on the workpiece holding portion 30 to determine, for instance, whether the workpiece 60 is within tolerance.

The robotic arm 20 of this example is a multiple degree of freedom articulated device typically used in automated manufacturing processes. While such a robotic arm 20 is depicted herein, it is not intended to be limiting. As such, it is contemplated that other types or forms of robotic arms or automated manipulators can be used to selectively hold the workpiece 60.

The workpiece holding portion 30 is configured to selectively hold a workpiece 60. While the workpiece 60 shown is generally cylindrical in shape, it is contemplated that workpieces of varying shapes and sizes can be selectively held by the workpiece holding portion 30 or by a different workpiece holding portion specifically configured for use with the differently sized and shaped workpiece holding portion. In such an example, the robotic arm 20 is configured to accept different workpiece holding portions configured to selectively hold different workpieces.

In one example, the workpiece holding portion 30 includes a generally tubular mandrel 31 having an interior 38 therethrough, a base 32, an end 34, and a generally cylindrical side wall 36. In one example, the base 32 is configured to couple to the robotic arm 20. The end 34 and the side wall 36 of this example are configured to fit within the workpiece 60. In one example, the side wall 36 of the mandrel 31 includes first and second ribs 36A, 36B, which extend generally circumferentially around the side wall 36. The ribs 36A, 36B are sized to create a relatively snug fit between the workpiece 60 and the workpiece holding portion 30 when the workpiece 60 is held by the workpiece holding portion 30. It is contemplated that the mandrel 31 of other examples can include more or less than two ribs or that the ribs be configured differently, such as being sized or shaped differently, provided the ribs function as described herein.

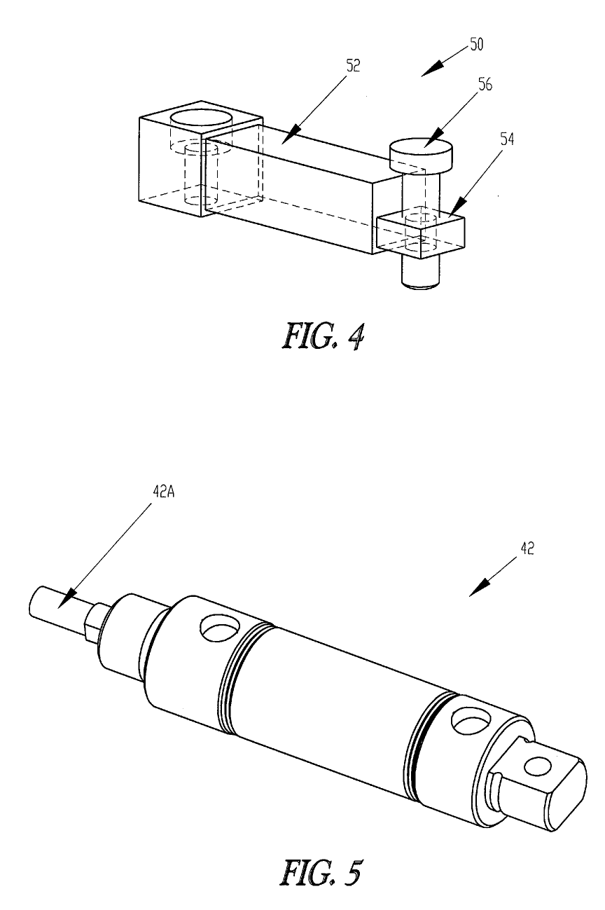

Referring to FIGS. 1, 3C, and 5, in one example, an actuator 42 is disposed within the interior 38 of the mandrel 31. The actuator 42 can be of any type, including, but not limited to a pneumatic cylinder or actuator, a hydraulic cylinder or actuator, an electric actuator or actuator, an electro-pneumatic cylinder or actuator, or a solenoid. In one example, the actuator 42 comprises a Bimba MRS-090.5-DXP air cylinder.

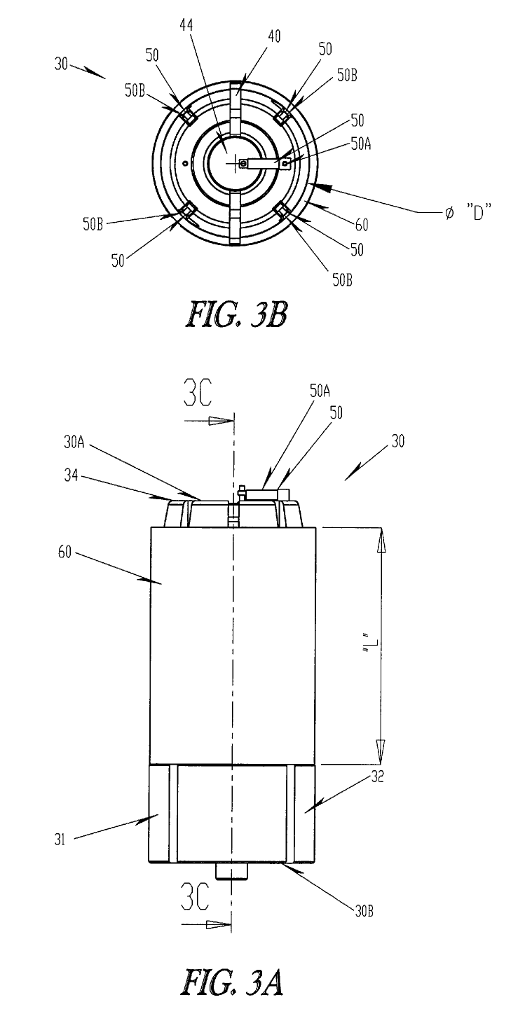

Referring to FIG. 3C, the actuator 42 includes a movable rod 42A disposed therein and configured to move in an axial direction with respect to the actuator 42. In the example shown, the rod 42A is coupled to an actuator guide 44, also disposed within the mandrel 31. In one example, the rod 42A is threadably coupled within a mating threaded hole 44A, although it is further contemplated that the rod 42A can be coupled to the actuator guide 44 in other ways, such as press fitting, interference fitting, welding, or using an adhesive. Movement of the rod 42A during actuation of the actuator 42 causes generally axial movement of the actuator guide 44 within the interior 38 of the mandrel 31.

The actuator guide 44 includes at least one notch 44B therein to mate with at least one gripping finger 40 for selectively releasably retaining the workpiece 60 on the mandrel 31 of the workpiece holding portion 30. In one example, the actuator guide 44 includes two notches 44B therein to mate with two gripping fingers 40, although it is contemplated that there can be more than two notches in the actuator guide 44 to accommodate more than two gripping fingers 40 if desired to retain the workpiece 60 on the workpiece holding portion 30.

In one example, the actuator 42 is coupled to the at least one gripping finger 40, such that the actuator 42 is configured to move the at least one gripping finger 40 with respect to the workpiece holding portion 30. In one example, the at least one gripping finger 40 is pivotably attached to the mandrel 31 at a pivot 40A. In certain examples, the at least one gripping finger 40 includes a cammed portion 40B that mates with the notch 44B, such that movement of the actuator guide 44 causes pivoting of the at least one gripping finger 40 about the pivot 40A. In one example, the at least one gripping finger 40 further includes a gripping portion 40C that extends outwardly from the pivot 40A, such that, in a gripping position (shown in FIG. 3C), the gripping portion 40C extends radially outwardly from the mandrel 31 to secure the workpiece 60 on the workpiece holding portion 30. For example, extending the rod 42A of the actuator 42 moves the actuator guide 44 toward the distal end 30A of the workpiece holding portion 30, which, in turn, pivots the at least one gripping finger 40 into the gripping position so that the gripping portion 40C extends radially outwardly from the mandrel 31. In this example, when in the gripping position, the at least one gripping finger 40 secures the workpiece 60 between the gripping portion 40C and a shoulder 31A of the mandrel 31. In one example, the at least one gripping finger 40 includes a released position in which the at least one gripping finger 40 is positioned to allow the workpiece 60 to be placed on or removed from the workpiece holding portion 30. For instance, retracting the rod 42A of the actuator 42 moves the actuator guide 44 toward the proximal end 30B of the workpiece holding portion 30, which, in turn, pivots the at least one gripping finger 40 into the released position so that the gripping portion 40C is radially within the mandrel 31, thereby allowing the workpiece 60 to pass by the at least one gripping finger 40.

Referring to FIGS. 1, 2, 3A, 3B, and 4, in certain examples, the workpiece holding portion 30 includes at least one measurement device 50 coupled therewith and configured to measure a property of the workpiece 60 while being held by the workpiece holding portion 30. In an example, the at least one measurement device 50 is configured to measure at least one dimension of the workpiece 60. In one example, the at least one measurement device 50 is a displacement transducer 50. In one example, the at least one measurement device 50 is a miniature measuring cell 50. For instance, the at least one measurement device 50 can be a TESTAR A124 miniature measuring cell.

In one example, the at least one measurement device 50 includes multiple measurement devices 50. In a further example, the multiple measurement devices 50 measure more than one property of the workpiece 60. For instance, the at least one measurement device 50 comprises multiple displacement transducers 50 configured to measure at least two dimensions of the workpiece 60. In one example, the displacement transducers 50 are configured to measure at least a length L (FIG. 3A) and a diameter D (FIG. 3B) of the workpiece 60. In a further example, the diameter D measured is an inner diameter D (FIG. 3B).

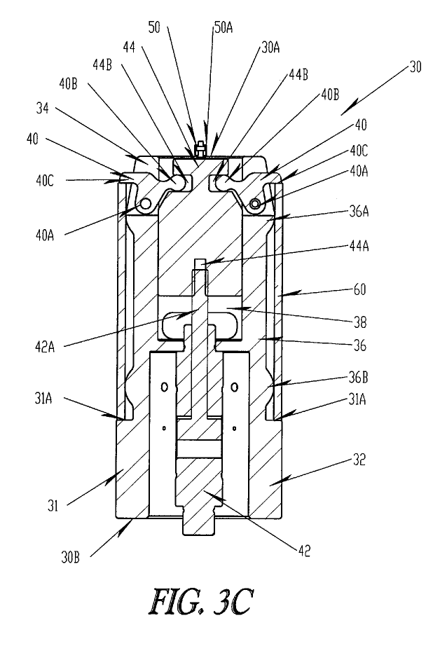

In the example shown in FIG. 4, the measurement device 50 includes a transducer 52 coupled to an armset 54 having a contact 56 attached thereto. The transducer 52 of the measurement device 50 is configured to generate a displacement signal based upon a geometry of the measurement device 50, including a fulcrum length of the transducer 52, armset 54, and contact 56. The contact 56 abuts the workpiece 60 or other item to be measured to cause a displacement, which is sensed by the transducer 52. The transducer 52 generates the displacement signal related to this displacement, such that the displacement signal can then be used to derive a measurement property by a controller or other such device associated with the workpiece holding portion 30. In this way, the displacement transducer 50 or plurality of displacement transducers 50 produce displacement signals indicative of a desired number of measurement properties of, for instance, the workpiece 60 retained by the workpiece holding portion 30.

In one example, the displacement transducers 50 include replaceable contacts 56 to allow replacement thereof after a predetermined amount of usage. The contact 56 is the only portion of the displacement transducer 50 that contacts the workpiece 60. Because of this interaction with the workpiece 60, the contact 56 is subject to wear. Because the contact 56 of this example is replaceable, the contact 56 can be removed after a desired amount of usage or wear and replaced with another contact 56, which could be unworn or less worn than the previous contact 56, to allow continued usage of the displacement transducer 50 without having to replace the entire displacement transducer 50. Also, the contact 56 could be replaced with another contact 56, for instance, if a different workpiece is being moved on the workpiece holding portion 30 and the different contact 56 is better suited for measuring a property of the different workpiece.

In the example shown herein, the workpiece holding portion 30 includes one length-measuring displacement transducer 50A and eight diameter-measuring displacement transducers 50B. In such a configuration, the length-measuring displacement transducer 50A is configured to be disposed at the distal end 30A of the workpiece holding portion 30. The reading from the length-measuring displacement transducer 50A of this example can be used to determine the overall length L of the workpiece 60 and to determine whether the workpiece 60 is within tolerance. In one example, the length-measuring displacement transducer 50A is attached to the distal end 30A such that the contact 56 (FIG. 4) abuts a top surface of the actuator guide 44. In this example, the position of the actuator guide 44 within the interior 38 of the mandrel 31 is related to the length L of the workpiece 60. Because the workpiece 60, when retained on the workpiece holding portion 30, is disposed between the shoulder 31A of the mandrel 31 and the gripping fingers 40, variations in sizes of the workpieces 60 cause different rotational orientations of the gripping fingers 40, which, in turn, causes variations in the position of the actuator guide 44 within the interior 38 of the mandrel 31. With proper calibration, the position of the actuator guide 44, as measured by the length-measuring displacement transducer 50A, is converted to a measurement of the length L of the workpiece 60.

The diameter-measuring displacement transducers 50B of this example are disposed around the outside of the workpiece holding portion 30 to gauge the inside diameter D of the workpiece 60 at least one cross section. In this example, the diameter-measuring displacement transducers 50B are configured to measure inside diameters D at two different cross sections, with four diameter-measuring displacement transducers 50B disposed proximate the distal end 30A of the workpiece holding portion 30 and four diameter-measuring displacement transducers 50B disposed proximate the proximal end 30B of the workpiece holding portion 30. In other examples, there can be more or less than four diameter-measuring displacement transducers 50B corresponding more or less than two cross sections of the workpiece 60, depending upon the geometry of the workpiece 60 and the desired number of gauging locations on the workpiece 60.

In another example, the workpiece holding portion 30 includes two length-measuring displacement transducers 50A. In such a configuration, the length-measuring displacement transducers 50A are configured to be disposed at opposing axial sides of the workpiece 60 when the workpiece 60 is retained by the workpiece holding portion 30. The readings from the length-measuring displacement transducers 50A of this example are can be used to determine the overall length L of the workpiece 60 and to determine whether the workpiece 60 is within tolerance. In one example, the length-measuring displacement transducer 50A at the distal end 30A of the workpiece holding portion 30 is attached to the gripping finger 40 to move therewith, so as to move the length-measuring displacement transducer 50A out of the way when accepting a workpiece 60 on the workpiece holding portion 30. When the gripping finger 40 moves into engagement with the workpiece 60, the length-measuring displacement transducer 50A is also moved into contact with the workpiece 60. Similarly, the length-measuring displacement transducer 50A is moved out of contact with the workpiece 60 when the gripping finger 40 is moved out of engagement with the workpiece 60 to allow the workpiece 60 to be removed from the workpiece holding portion 30.

In certain examples, the workpiece holding portion 30 includes measurement devices 50 that measure one or more other properties of the workpiece 60, such as, for instance, surface hardness, surface finish quality, curvature radius, outer diameter, or hole diameter. Such a measurement device 50 can include a displacement transducer, a laser measurement device, or a camera.

Referring to FIGS. 1-6, an example of a method includes receiving the workpiece 60 on the workpiece holding portion 30. At least one property of the workpiece 60 is automatically measured while the workpiece 60 is moved from a first location or station 70 to a second location or station 80. In one example, the first and second stations 70, 80 are stations in a machining operation. For instance, the first station 70 can be a CNC machine or other such manufacturing device, a conveyor belt, a finishing machine, or a pallet, and the second station 80 can be a CNC machine or other such manufacturing device, a conveyor belt, a finishing machine, or a pallet. The method includes releasing the workpiece 60 from the workpiece holding portion 30, for instance, at the second station 80. In one example, the workpiece 60 is automatically measured or gauged while the workpiece 60 is moved from the first station 70 to the second station 80, such that a user need not necessarily remove the workpiece 60 from the operation, machining or otherwise, to measure or gauge the workpiece 60, thereby lessening stoppages of the operation.

In one example, at least one dimension of the workpiece 60, such as the length L or the inner diameter D, is automatically measured. In one example, variation of the at least one property of a plurality of workpieces 60 is monitored. By monitoring variation, a manufacturing parameter of the workpiece 60 can be adjusted to maintain variation of the at least one property of the workpiece 60 within a desired tolerance. In this way, if desired, the workpieces 60 can be maintained within a particular tolerance, such that the workpieces 60 are substantially similar. If the workpieces 60 begin to deviate from the tolerance, one or more parameters of the operation, such as a setting of the CNC machine, for instance, can be changed to maintain the workpieces 60 within tolerance. By dynamically changing parameters in this way, there is less of a need for stopping the operation and workpieces 60 can be manufactured more efficiently.

In one example, the method includes replacing the workpiece holding portion 30 with a different workpiece holding portion configured to receive a different workpiece. For instance, the robotic arm 20 or other device can be configured to releasably retain the workpiece holding portion 30 so that the workpiece holding portion 30 can be removed therefrom and replaced with a different workpiece holding portion sized and shaped to accept a different workpiece. For instance, the different workpiece can be sized or shaped differently than the workpiece 60 previously being manufactured. The apparatus 10 can then be used to move the different workpieces with relatively little transition time, thereby lessening the need for multiple apparatuses 10 for different workpieces. In this way, costs arising from additional equipment and from downtime can be lessened.

In certain examples, more than one property of the workpiece 60 can be measured concurrently. In one example, the length L and the diameter D of the workpiece 60 can be automatically measured. In one example, the inner diameter D of the workpiece 60 is automatically measured. In one example, the length L and the diameter D of the workpiece 60 can be automatically measured concurrently.

As discussed above in the examples of the apparatus 10 and method, by automatically measuring at least one property of the workpiece 60 while moving the workpiece 60 from one location to another, the workpiece can be gauged without removing the workpiece 60 from the operation. By doing so, the operation need not be slowed or stopped to gauge the workpiece 60. In this way, quality of the workpiece 60 can be maintained within a desired range in a way that does not necessarily increase manufacturing time for the workpiece 60. This, in turn, can make the operation more efficient, thereby potentially decreasing time and costs of producing the workpiece 60. Additionally, by automatically measuring the workpiece 60 while moving the workpiece 60 from one location to another, two tasks in the operation can be accomplished concurrently, which can decrease overall time needed for performing the operation, as well as potentially decreasing costs associated with producing the workpiece 60.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

What is claimed is:

1. An apparatus, comprising:
a robotic arm;
a workpiece holding portion coupled to the robotic arm and configured to selectively hold a workpiece;
at least one measurement device coupled with the workpiece holding portion and configured to measure a property of the workpiece while being held by the workpiece holding portion.

2. The apparatus of claim 1, wherein the workpiece holding portion is removable from the robotic arm, the robotic arm being configured to accept different workpiece holding portions configured to selectively hold different workpieces.

3. The apparatus of claim 1, wherein the workpiece holding portion is coupled to an end of the robotic arm.

4. The apparatus of claim 1, comprising at least one gripping finger configured to selectively retain the workpiece on the workpiece holding portion.

5. The apparatus of claim 4, comprising an actuator coupled to the at least one gripping finger, the actuator being configured to move the gripping finger with respect to the workpiece holding portion.

6. The apparatus of claim 1, wherein the at least one measurement device is configured to measure at least one dimension of the workpiece.

7. The apparatus of claim 1, wherein the at least one measurement device comprises a displacement transducer.

8. The apparatus of claim 1, wherein the at least one measurement device comprises multiple displacement transducers configured to measure at least two dimensions of the workpiece.

9. The apparatus of claim 8, wherein the displacement transducers are configured to measure at least a length and a diameter of the workpiece.

10. The apparatus of claim 9, wherein the diameter measured is an inner diameter.

11. A method, comprising:
receiving a workpiece on a workpiece holding portion;
automatically measuring at least one property of the workpiece while the workpiece is moved from one location to another; and
releasing the workpiece from the workpiece holding portion.

12. The method of claim 11, wherein automatically measuring at least one property includes measuring at least one dimension of the workpiece.

13. The method of claim 11, comprising monitoring variation of the at least one property of a plurality of workpieces.

14. The method of claim 13, comprising adjusting a manufacturing parameter of the workpiece to maintain variation of the at least one property of the workpiece within a desired tolerance.

15. The method of claim 11, comprising replacing the workpiece holding portion with a different workpiece holding portion configured to receive a different workpiece.

16. The method of claim 11, wherein automatically measuring at least one property comprises measuring more than one property of the workpiece concurrently.

17. The method of claim 11, wherein automatically measuring at least one property comprises measuring a length and a diameter of the workpiece.

18. The method of claim 17, wherein measuring the diameter comprises measuring an inner diameter of the workpiece.

19. The method of claim 17, wherein automatically measuring at least one property comprises measuring a length and a diameter of the workpiece concurrently.

20. The method of claim 11, wherein automatically measuring at least one property of the workpiece while the workpiece is moved from one location to another comprises moving the workpiece between stations in a machining operation.

21. An apparatus, comprising:
a robotic transport arm including a workpiece holding portion configured to selectively retain a workpiece; and
means for automatically measuring at least one property of the workpiece while the workpiece retained on the workpiece holding portion.

22. The apparatus of claim 21, comprising at least one gripping finger configured to selectively retain the workpiece on the workpiece holding portion.

23. The apparatus of claim 21, wherein the means for automatically measuring at least one property of the workpiece comprises a displacement transducer.

24. The apparatus of claim 23, wherein the displacement transducer is configured to measure a linear dimension of the workpiece.
